(19) United States
(12) Patent Application Publication
(10) Pub. No.: US 2007/0083864 A1
(43) Pub. Date: Apr. 12, 2007

(54) State management method and portable terminal

(75) Inventors: Hiroshi Suzuki, Nishitama-gun (JP); Akira Nakayama, Akishima-shi (JP); Shinichi Amano, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/375,281

(22) Filed: Mar. 14, 2006

(30) Foreign Application Priority Data
Oct. 7, 2005 (JP) 2005-295309

(51) Int. Cl. G06F 9/46

(52) U.S. Cl. 718/100

(57) ABSTRACT

A state management method for managing the states of the first and second tasks based on a first table for managing a state of a first task which belongs to a first system and a second table for managing a state of a second task which belongs to a second system which is different from the first system, includes obtaining a second event to be transmitted to the second task based on a first event which has occurred in the first task, transmitting the obtained second event to the second task, and changing a state referring to the second table based on the second event when the second task receives the second event.

### CROSS-REFERENCE TO RELATED APPLICATIONS

This application is based upon and claims the benefit of priority from prior Japanese Patent Application No. 2005-295309, filed Oct. 7, 2005, the entire contents of which are incorporated herein by reference.

### BACKGROUND OF THE INVENTION

1. Field of the Invention

The present invention relates to a method of managing a plurality of states having different systems and a portable terminal to which this state management method is applied.

2. Description of the Related Art

State machines each belongs to different systems are controlled in accordance with a state transition table having different modes which are different from each other depending on the respective state machines. Thus, in order to control each of the state machines, it is necessary to independently control the state transition table.

For example, a state machine having a first system and a second system will be described below. In this case, the first system is controlled in accordance with a state transition table of the first system mode, and the second system is controlled in accordance with a state transition table of the second system mode. Here, these two difference modes of the first and second systems do not coincide with each other in control according to their respective state transition tables, and it is impossible for the two systems to have cooperation.

### BRIEF SUMMARY OF THE INVENTION

It is an object of the present invention to provide a state management method capable of cooperatively operating two or more state machines having different systems, and a portable terminal to which the state management method has been applied.

According to the present invention, in state machines each belongs to different systems, tasks which absorb a difference in control according to state transition tables in modes different from each other depending on the respective systems and which belong to the plurality of different systems, are controlled at the same time like control according to a state transition table of a task which belongs to a nominal single system.

Specifically, a state management method for managing the states of the first and second tasks based on a first table for managing a state of a first task which belongs to a first system and a second table for managing a state of a second task which belongs to a second system which is different from the first system, according to one aspect of the present invention is characterized by including: obtaining a second event to be transmitted to the second task based on a first event which has occurred in the first task; transmitting the obtained second event to the second task; and changing a state referring to the second table based on the second event when the second task receives the second event.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of a system configuration of a state machine according to an embodiment of the present invention;

FIG. 2 is a schematic perspective view of a portable electronic device which is an example of the state machine according to the embodiment of the invention;

FIG. 3 is a diagram showing a set of state transition tables for use in control of each task according to the embodiment of the invention;

FIG. 4A to FIG. 4C are views each showing a state transition table held by a task which belongs to at least one of a first system and a second system 102;

FIG. 5A and FIG. 5B are views each showing a state transition table held by a task which belongs to the second system 102;

FIG. 6 is a block diagram depicting an internal configuration of tasks which belong to both of the first system and the second system according to the embodiment of the invention;

FIG. 7 is a chart showing a sequence when a state of the task which belongs to the second system is changed together with the task which belongs to the first system;

FIG. 8 is a flow chart showing a flow of a processing operation of a proxy section from the receipt of an event of the first system to transmission of an event of the second system;

FIG. 9 is a view showing a correlation table between the event of the second system and the event of the first system event;

FIG. 10 is a chart showing a sequence when the state of the task which belongs to the second system is changed together with the task which belong to the first system; and

FIG. 11 is a sequence chart showing a specific control example.

### DETAILED DESCRIPTION OF THE INVENTION

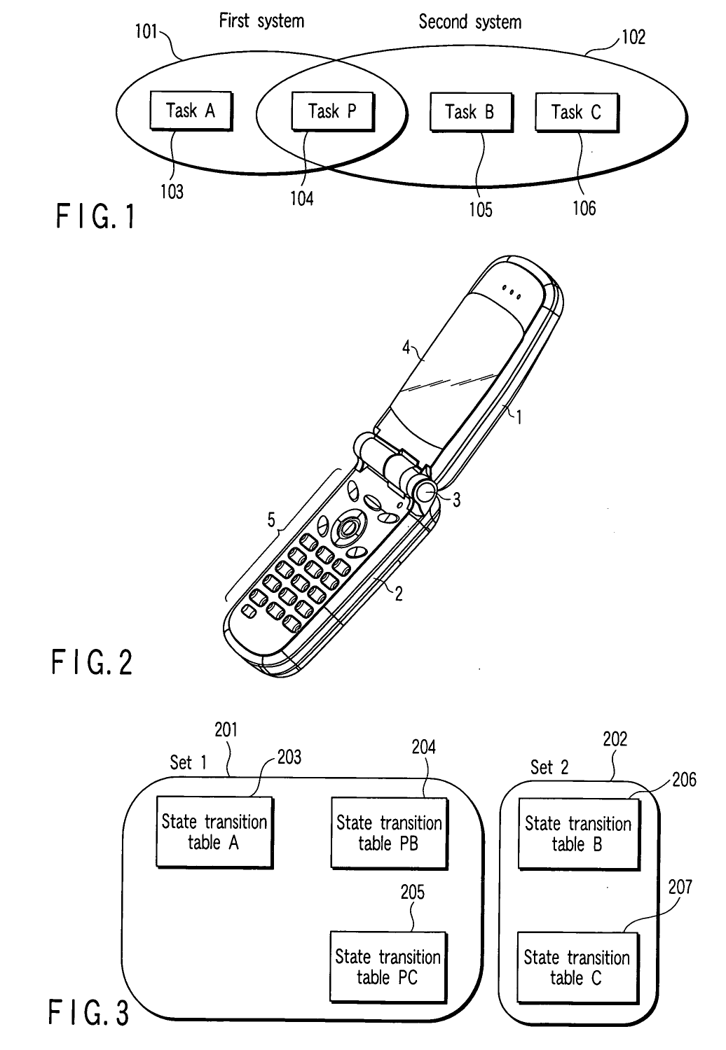

Hereinafter, one embodiment of the present invention will be described with reference to the accompanying drawings. FIG. 1 is a diagram showing an example of a system configuration of a state machine according to an embodiment of the present invention. Although FIG. 1 shows two systems for the sake of explanatory convenience, three or more different systems can be made coincident with each other in the embodiment of the invention.

A state machine shown in FIG. 1 has a first system 101 and a second system 102 which are controlled in accordance with their respective state transition tables. A task A (103) belongs to the first system 101, and a task B (105) and a task C (106) belong to the second system 102. In addition, a task P (104) belongs to both of the first system 101 and the second system 102.

FIG. 2 is a schematic perspective view of a portable electronic device which is an example of the state machine according to the embodiment of the invention. The portable electronic device is a so-called retractable portable communication terminal in which an upper casing 1 and a lower casing 2 are turnably connected to each other via a hinge mechanism 3. FIG. 2 shows a state in which each of the casings 1 and 2 is opened.

In the upper casing 1, a main liquid crystal display (LCD) 4 is arranged on its front face, and a subsidiary LCD (not shown) is arranged on its rear face. On the other hand, in the lower case 2, a main printed circuit board (not shown) is housed together with a key input device 5 or the like. Here, the first system 101 is a portion according to its essential functions such as a telephone directory and call functions possessed by which a portable electronic device, and the second system 102 is an external application such as e-mail or browser. Thus, in general, the first system 101 and the second system 102 cannot have cooperation. However, in the embodiment of the invention, a task is provided which belongs to both of the first system 101 and the second system 102 as shown in FIG. 1 so as to intermediate a difference in control according to the state transition table in each of the systems. Now, a specific description will be given below.

FIG. 3 is a view showing a set of state transition tables for use in control of each of the tasks according to the embodiment of the invention.

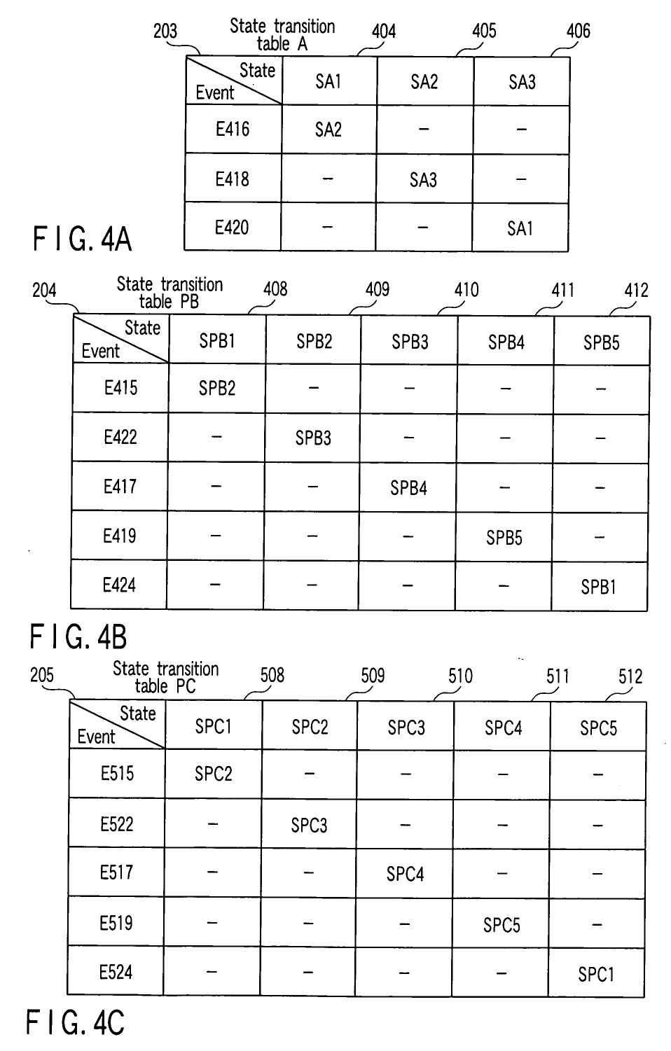

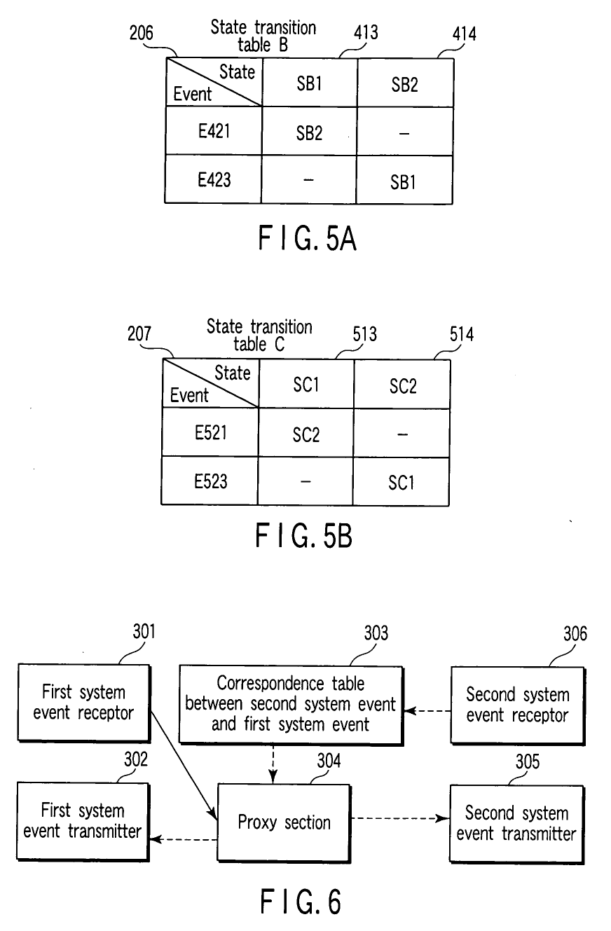

In FIG. 3, the task A (103) shown in FIG. 1 is controlled by using a state transition table A (203) in a mode of the first system 101. The task B (105) is controlled by a state transition table B (206) in a mode of the second system 102 which is different from the first system 101. The task C (106), like the task B, belongs to the second system 102. Therefore, this the task C (106) is controlled by using a state transition table C (207) in a mode of the second system 102 which is different from the mode of the first system 101. The task P (104) controls the task B (105) and the task C (106) at the same time under the control according to the state transition table in the same mode as that of the first system 101. Thus, the task P (104) comprises a state transition table PB (204) in the mode of the first system 101 for the task B (105); and a state transition table PC (205) in the mode of the first system 101 for the task C (106). Detailed views of their respective state transition tables are shown in FIG. 4A to FIG. 5B.

FIG. 6 is a block diagram depicting an internal configuration of the task P (104) which belongs to both of the first system 101 and the second system 102 according to the embodiment of the invention.

The task P (104) which belongs to both of the first system 101 and the second system 102 controls a first system event receptor 301 which receives an event from the task A (103), a correlation table 303 between the event of the second system 102 and the event of the first system 101, and the task B (105) and task C (106) from the event of the first system 101. In addition, the task P comprises: a proxy section 304 which intermediates a difference in control according to state transition tables in modes different from each other depending on the first system 101 and the second system 102; a second system event transmitter 305 which transmits an event to the second system 102; a first system event transmitter 302 which transmits an event to the first system 101; and a second system event receptor 306 which receives an event from the second system 102.

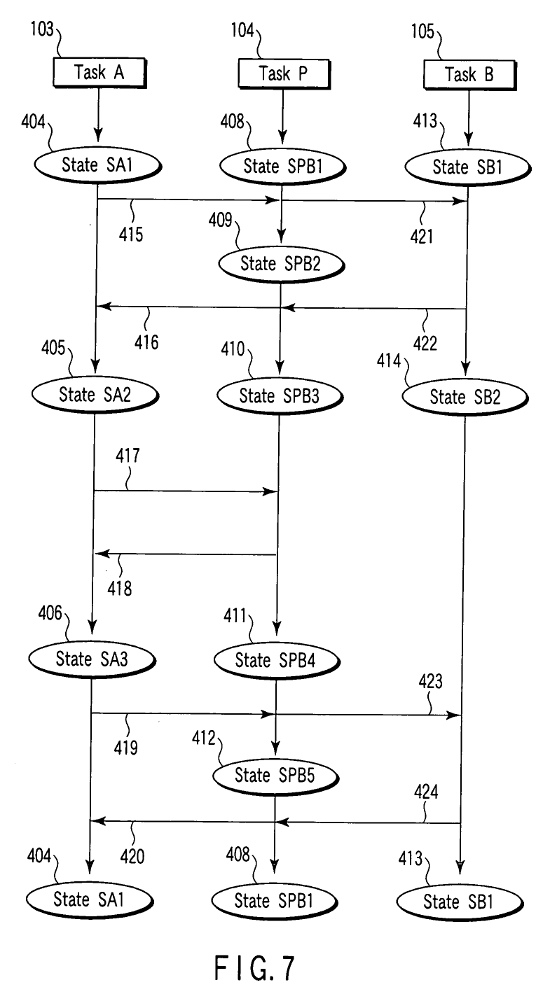

Now, a cooperative operation of a plurality of systems different from one another with a configuration according to the present embodiment will be described with reference to FIG. 7.

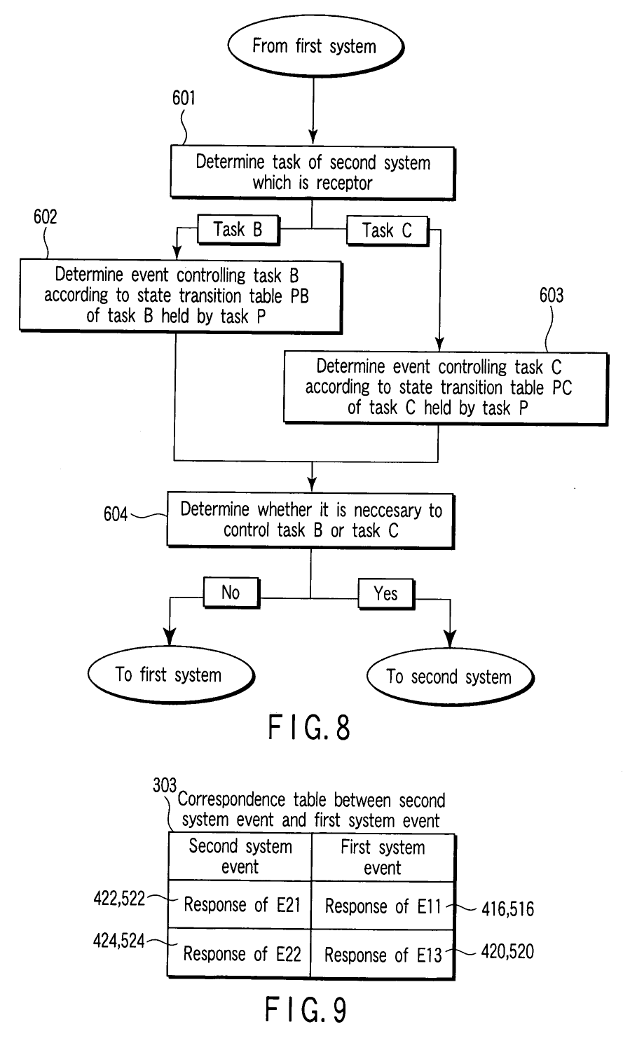

As shown in FIG. 7, an event E416 (405) for controlling the task B (105) is transmitted to the task P (104) from the task A (103) whose state is SA1 (404). Then, when the task P (104) receives the event E416 (415), the proxy section 304 carries out a process for cooperatively operating the first system 101 and the second system 102. A flow of a processing operation of the proxy section 304 will be described with reference to FIG. 8 and FIG. 9. FIG. 9 shows a correlation table between the event of the second system and the event of the first system in the task P.

As shown in FIG. 8, when the task P (104) receives the event E416 (415) from the task A (103), it determines a task of the second system 102 which is a transmission destination (601).

When it is determined that the transmission destination is task B (105), a process for controlling an operation of the task B (105) is determined when the event E416 (415) has been received in a state SPB1 (408) (602 and 604).

Then, the processing of the second system event transmitter 305 which transmits from the task P (104) the event E415 (421) for controlling the task B (105) is started.

When the second system event transmitter 305 starts the processing, the E415 event (421) is transmitted to the task B (105).

The task B (105) in the state SB1 (412) having received the E415 event ((421) transmitted from the task P (104) carries out its own task process, and transmits to the task P (104) a response event E421 (422) which is a response to the E415 event (421).

Here, the task P (104) having received the response event E421 (422) of E415 from the task B (105) at the second system event receiver 306 acquires a response event E422 (416) of E416 which corresponds to the response event E421 (422) of E415 from the correlation table 303 between the event of the second system and the event of the first system event, and transmits the response event E422 (416) of E416 from the first system event transmitter (301) to the task A (103). Then, the task A (103) receives the response event E422.

At this time, the task A (103) is changed to a state SA2 (405), a state of the task P (104) relevant to the task B (05) is changed to SPB2 (409), and the task B (105) is changed to a state SB2 (413), respectively.

Next, as shown in FIG. 7, an event E418 (417) for controlling the task B (105) is transmitted to the task P (104) from the task A (103) whose state is SA2 (405). Then, when the task P (104) receives the event E418 (417), the proxy section 304 carries out a process for cooperatively operating the first system 101 and the second system 102. A flow of a processing operation of the proxy section 304 will be described with reference to FIG. 8 and FIG. 9.

As shown in FIG. 8, when the task P (104) receives the event E418 (417) from the task A (103), it determines the task of the second system 102 which is a transmission destination (601).

When it is determined that the transmission destination is task B (105), a process for controlling an operation of the task B (105) when the event E418 (417) has been received in the state SPB3 (409) is determined from the state transition table PB (204) of the task B (105) held by the task P (104) (602 and 604).

Because the second system 102 does not have a process which corresponds to a process of the first system 101 when the event E418 (417) has received, the task P (104) does not transmit an event to the task B (105). In addition, in order to transmit the response event E417 (418) of E418 to the task A (103), the processing of the first system event transmitter 302 is started.

When the processing of the first system event transmitter 302 is started, a response event E417 (418) of E418 is transmitted from the task P (104) to the task A (103), and the task A (103) receives the response event E417 (418) of E418.

At this time, the task A (103) is changed to a state SA3 (406) and a state of the task P (104) relevant to the task B (105) is changed to a state SPB3 (410), respectively. However, the task B (105) remains the state SB2 (413).

Further, as shown in FIG. 7, an event E420 (419) for controlling the task B (105) is transmitted to the task P (104) from the task A (103) whose state is SA3 (406). Then, when the task P (104) receives the event E420 (419), the proxy section 304 carries out a process for cooperatively operating the first system 101 and the second system 102. A flow of a processing operation of the proxy section 304 will be described with reference to FIG. 8 and FIG. 9.

As shown in FIG. 8, when the task P (104) receives the event E420 (419) from the task A (103), it determines a task of the second system 102 which is a transmission destination (601).

When it is determined that the transmission destination is task B (105), a process for controlling an operation of the task B (105) is determined when the event 420 (419) has been received in the state SPB3 (406) from the state transition table PB (204) of the task B (105) held by the task P (104) (602 and 604).

Then, the processing of the second system event transmitter 305 which transmits an event E419 (423) for controlling the task B (105) from the task P (104) is started.

When the processing of the second system event transmitter 305 is started, the E419 event (423) is transmitted to the task B (105).

The task B (105) in the state SB2 (413) having received the E419 event (423) transmitted from the task P (104) carries out its own task processing, and transmits to the task P (104) a response event E423 (424) of E419 which is a response to the E419 event (423).

Here, the task P (104) having received the response event E423 (424) of E419 from the task B (105) at the second system event receptor 306 acquires a response event E424 (420) of E420 which corresponds to the response event E423 (424) of E419 from the correlation table 303 between the event of the second system and the event of the first system, and transmits the response event E424 (420) of E420 from the first system transmitter (301) to the task A (103). Then, the task A (103) receives the above response event E424 (420).

At this time, the task A (103) is changed to a state SA1 (404), a state of the task P (104) relevant to the task B (105) is changed to a state SPB1 (408), and the task B (105) is changed to a state SB1 (412), respectively.

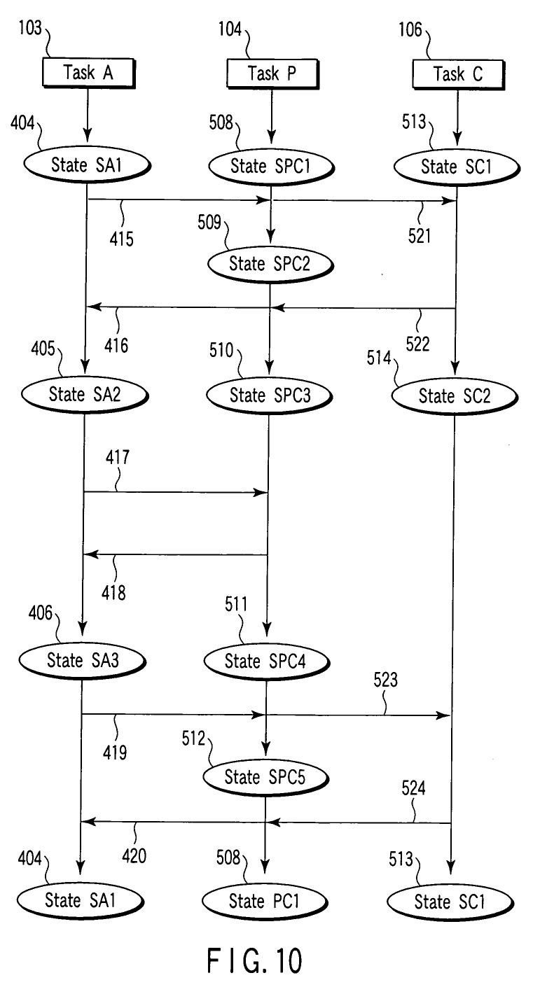

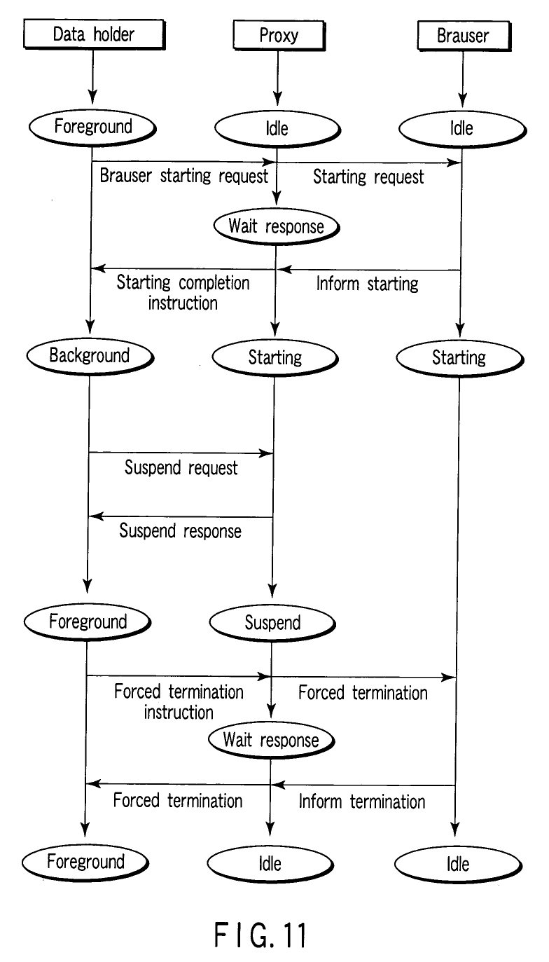

Further, with reference to FIG. 10, a description will be given with respect to a cooperative operation which is cooperative with the first system 101 of the task C (106) which is not the task B (105) which belongs to the second system 102.

As shown in FIG. 10, an event E416 (415) for controlling the task C (106) is transmitted to the task P (104) from the task A (103) whose state is SA1 (404). Then, when the task P (104) receives the event E416 (415), the proxy section 304 carries out a process for cooperatively operating the first system 101 and the second system 102. A flow of a processing operation of the proxy section 304 will be described with reference to FIG. 8 and FIG. 9.

As shown in FIG. 8, when the task P (104) receives the event E416 (415) from the task A (103), it determines a task of the second system 102 which is a transmission destination (601).

When it is determined that the transmission destination is the task C (106), a process for controlling an operation of the task C (106) is determined when the event E416 (415) has been received in a state SPC1 (508) from the state transition table PC (205) of the task C (106) held by the task P (104) shown in FIG. 4 (603 and 604).

Then, the processing of the second system event transmitter 305 which transmits an event E515 (521) for controlling the task C (106) from the task P (104) is started.

When the processing of the second system event transmitter 305 is started, the E515 event (521) is transmitted to the task C (106).

The task C (106) in the state SC1 (512) having received the E515 event (521) transmitted from the task P (104) carries out its own task processing, and transmits to the task P (104) a response event E521 (522) of E515 which is a response to the E515 event (521).

Here, the task P (104) having received the response event E521 (522) of E515 from the task C (106) at the second system event receptor 306 acquires a response event E522 (416) of E416 which corresponds to the response event E521 (522) of E515 from the correlation table 303 between the event of the second system and the event of the first system, and transmits the response event E522 (416) of E416 from the first system event transmitter (301). Then, the task A (103) receives the above response event E522 (416).

At this time, the task A (103) is changed to a state SA2 (405), a state of the task P (104) relevant to the task C (106) is changed to a state SPC2 (509), and the task C (106) is changed to a state SC2 (514), respectively.

Next, as shown in FIG. 10, an event E418 (417) for controlling the task C (106) is transmitted to the task P (104) from the task A (103) whose state is SA2 (405). Then, when the task P (104) receives the event E418 (417), the proxy section 304 carries out a process for cooperatively operating the first system 101 and the second system 102. A flow of a processing operation of the proxy section 304 will be described with reference to FIG. 8 and FIG. 9.

As shown in FIG. 8, when the task P (104) receives the event E418 (417) from the task A (103), it determines a task of the second system 102 which is a transmission destination (601).

When it is determined that the transmission destination is the task C (106), a process for controlling an operation of the task C (106) is determined when the event 418 (417) has been received in the state SPC2 (509) from the state transition table PC (205) of the task C (106) held by the task P (104) (603 and 604).

The second system 102 does not carry out a processing operation which corresponds to a processing operation of the first system 101 when the event E418 (417) has been received. Thus, the task P (104) does not transmit an event to the task C (106), and the processing of the first system event transmitter 302 is started in order to transmit the response event E517 (418) of E418 to the task A (103).

When the processing of the first system event transmitter 302 is started, a response event E517 (418) of E418 is transmitted from the task P (104) to the task A (103), and the task A (103) receives the response event 517 (418) of E418 to the task A (103).

At this time, the task A (103) is changed to a state SA3 (406) and a state of the task P (104) relevant to the task C (106) is changed to a state SPC3 (510), respectively. However, the task C (106) remains the state SC2 (514).

Further, as shown in FIG. 10, an event 420 (419) for controlling the task C (106) is transmitted to the task P (104) from the task A (103) whose state is. SA3 (406). Then, when the task P (104) receives the event 420 (419), the proxy section 304 carries out a process for cooperatively operating the first system 101 and the second system 102. A flow of a processing operation of the proxy section 304 will be described with reference to FIG. 8 and FIG. 9.

As shown in FIG. 8, when the task P (104) receives the event E420 (419) from the task A (103), it determines the task of the second system 102 which is a transmission destination (601).

When it is determined that the transmission destination is the task C (106), a process for controlling an operation of the task C (106) is determined when the event E420 (419) has been received in the state SPC3 (506) from the state transition table PC (205) of the task C (106) held by the task P (104) (603 and 604).

Then, the processing of the second system event transmitter 305 which transmits an event E519 (523) for controlling the task C (106) from the task P (104) is started.

When the processing of the second system event transmitter 305 is started, the E519 event (523) is transmitted to the task C (106).

The task C (106) in the state SC2 (514) having received the E419 event (523) transmitted from the task P (104) carries out its own task processing, and transmits to the task P (104) a response event E523 (524) of E519 which is a response to the E519 event (523).

Here, the task P (104) having received the response event E523 (524) of E519 from the task C (106) at the second system event receptor 306 acquires a response event E524 (420) of E420 which corresponds to the response event E523 (524) of E519 from the correlation table 303 between the event of second system and the event of the first system, and transmits the response event E524 (420) of E420 from the-first system event transmitter (301) to the task A (103). Then, the task A (103) receives the above response event E524 (420).

At this time, the task A (103) is changed to a state SA1 (404), a state of the task P (104) relevant to the task C (1006) is changed to a state SPC1 (508), and the task C (106) is changed to a state SC1 (512), respectively.

As described above, according to the present embodiment, tasks belongs to different systems can be controlled at the same time like control according to a state transition table of a task which belongs to one system. Now, a specific example of an operation will be described with reference to FIG. 11.

First, a description will be given, assuming that there exist a first system and a second system which are different from each other, and further, there exist a task holder which belongs to the first system, a task browser which belongs to the second system, and further, a task proxy which belongs to the first system and the second system.

At this time, the data holder is handled as a foreground state (a state in which a screen is set at a frontal position) in the first system. In addition, the browser is handled as an idle state (inactive state) in the second system, and the proxy is handled as an idle state of the first system in order to cooperatively operate as a task of the first system.

When a browser startup request is transmitted to the proxy by means of the data holder, the proxy transmits a startup request to the browser in accordance with a browser state table possessed by the proxy. Then, the proxy is changed to a wait state in which it waits for a response to the startup request. Although this wait state is not a state possessed by both of the first system and the second system, this state is required to cooperatively operate two systems, and is a state unique to the proxy.

The browser receives a startup request from the proxy, carries out a startup process to change to an active state, and transmits a startup notification to the proxy. Here, the foreground state of the first system corresponds to the active state of the second system.

The proxy having been established in the wait state receives the startup notification, transmits to the data holder a startup completion command which is a response from the first system, and changes a state management table of the proxy to the foreground state of the first system. The data holder having received the startup completion command changes a current state to a background state (a state in which a screen is not set at a frontal position).

Next, there occurs a need for the data holder having been established in the background state to set its own task to the foreground state for any reason, and an interrupt request is transmitted to the proxy in order to suspend the browser which is currently established in the foreground state in the first system.

There is a need for the proxy having received the interrupt request to change the browser to the suspended state, and further, to transmit its response to the data holder. However, since there is no support for such a suspended state in the second system, it is impossible to transmit the interrupt request to the browser. Therefore, there is a need for absorbing its difference by the proxy.

The proxy in the foreground state having received the interrupt request cannot transmit the interrupt request, and cannot receive an interrupt response. The proxy transmits its interrupt response to the data holder instead of the browser, and changes a current state to the suspended state of the first system. At this time, while the browser is in an active state of the second system, the proxy is in the suspended state, thereby making it possible to handle the current state as the suspended state under the control of the first system. In this way, the proxy intermediates the state difference between the different systems, thereby enabling inter-task control without any discrepancy between the first and second systems.

Further, a forced end command is transmitted from the data holder to the proxy. The proxy having received this command transmits a forced end command of the second system to the browser, and changes the current state to the wait state.

The browser in the active state having received the forced end command carries out an end processing, transmits an end notification to the proxy, and changes the current state to the idle state of the second system.

The proxy having received the end notification which is a response from the browser to the forced end command transmits to the data holder the forced end response which is a response from the first system, and changes to the idle state of the first system.

In this way, the present invention can absorb differences in event types, methods, and states which are transmitted or received between the different systems, can operate the different systems cooperatively each other, and can operate them as if they were a single system.

As has been described above, it is expected to improve development efficiency of a new state machine by cooperatively operating systems having state transition tables in different modes, and then, operating state machines which do not coincide with each other together.

According to the present invention, tasks having a plurality of different systems and belonging to the respective systems can control, in accordance with a state transition table in a mode of one of the systems, the state machines which are controlled in accordance with state transition tables in modes different from each other depending on the systems. Consequently, when a state machine is produced, it becomes possible to use non-coincident systems for development of a new state machine by cooperatively operating systems which do not coincide with each other, and it becomes possible to improve development efficiency of state machines.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A state management method for managing the states of the first and second tasks based on a first table for managing a state of a first task which belongs to a first system and a second table for managing a state of a second task which belongs to a second system which is different from the first system, the method comprising:
obtaining a second event to be transmitted to the second task based on a first event which has occurred in the first task;
transmitting the obtained second event to the second task; and
changing a state referring to the second table based on the second event when the second task receives the second event.

2. A portable terminal comprising having a first task which belongs to a first system and a second task which belongs to a second system, and comprising first and second state managers which manages states of the first and second tasks, respectively, based on a first table for managing the state of the first task and a second table for managing the state of the second task, the portable terminal comprising:
a conversion table which holds a correlation between a first event which is generated in the first task and a second event for controlling the second task based on the first event;
an event extracting unit which obtains a second event referring to the conversion table when the first event is received from the first task; and
a controller which transmits the second event extracted by the event extracting unit to the second task, thereby controlling the second task.

3. A portable terminal according to claim 2, wherein, when the second event is received from the task controller, the second state manager makes a change in the state of the second task referring to the second table.

4. A portable terminal comprising having a first task which belongs to a first system and a second task which belongs to a second system, and comprising first and second state managers which manages states of the first and second tasks, respectively, based on a first table for managing the state of the first task and a second table for managing the state of the second task, the portable terminal comprising:
a conversion table which holds a correlation between a first event which is generated in the first task and a second event for controlling the second task based on the first event and a correlation between a third event which is generated in the second task and a fourth event for controlling the first task based on the third event;
an event extracting unit which obtains a second event referring to the conversion table when the first event is received from the first task, and obtains a fourth event referring to the conversion table when the third event is received from the second task; and
a task controller which transmits the second and fourth events extracted by the event extracting unit, thereby controlling the first and second tasks.

5. A portable terminal according to claim 4, wherein the third event is outputted according to the second task whose state has been changed based on the second event.
